(19) United States
(12) Patent Application Publication
(10) Pub. No.: US 2018/0204130 A1
(43) Pub. Date: Jul. 19, 2018

(54) MESSAGE CHOICE MODEL TRAINER

(71) Applicant: INTERNATIONAL BUSINESS MACHINES CORPORATION, Armonk, NY (US)

(72) Inventors: Fiona M. Crowther, Oldham (GB); Geza Geleji, Eastleigh (GB); Christopher J. Poole, Romsey (GB); Martin A. Ross, Gosport (GB); Craig H. Stirling, Hedge End (GB)

(21) Appl. No.: 15/405,816

(22) Filed: Jan. 13, 2017

(51) Int. Cl. G06N 7/00; G06N 5/02

(52) U.S. Cl. CPC G06N 7/005; G06N 5/02

(57) ABSTRACT

This invention relates to a message choice model trainer, method and computer program product for training a choice model for use by a parser when parsing message model choices, said method comprising: determining a selected choice element for a message model and message during parsing; determining that a message has the same set of message properties as a saved set of message properties, said saved set of message properties having an associated choice probability for at least one of the choice elements; and updating the choice probability associated with the saved set of message properties based on the determined choice element.

### BACKGROUND

The present invention relates to a message choice model trainer and method for training a choice model for parsing message model choices.

Message models provide a method for describing the logical structure of message data. A message model can include a choice block of choices between elements at different levels within the structure. The choice block enables a developer to model a message such that a particular element may be one of a plurality of elements. In order for the run-time to parse a message efficiently by choosing the correct message model structure, the run-time needs to be trained in the relative probabilities of each element depending on the context.

### SUMMARY

In a first aspect of the invention there is provided a message choice model trainer system for training a choice model for use by a parser when parsing message model choices. The message choice model trainer system includes: a processor, a computer readable memory, and a computer readable storage medium associated with a computer device; program instructions of a choice element determiner configured to determine a choice element for a message model and message during parsing; program instructions of a message property engine configured to determine that the message has the same set of message properties as a saved set of message properties, said saved set of message properties having an associated choice probability for at least one of the choice elements; and program instructions of a choice probability updater configured to update the choice probability associated with the saved set of message properties based on the determined choice element. The program instructions are stored on the computer readable storage medium for execution by the processor via the computer readable memory.

In a second aspect of the invention there is provided a computer implemented method for training a choice model for parsing message model choices. The method includes: determining, by a computer device, a choice element for a message model and a message during parsing; determining, by the computer device, that the message has the same set of message properties as a saved set of message properties, said saved set of message properties having an associated choice probability for at least one of the choice elements; and updating, by the computer device, the choice probability associated with the saved set of message properties based on the determined choice element.

In a third aspect of the invention there is provided a computer program product for training a choice model for use by a parser when parsing message model choices, the computer program product comprising a computer readable storage medium having program instructions embodied therewith, the program instructions executable by a processor to cause the processor to: determine a choice element for a message model during message parsing; determine that a message has the same set or sub-set of message properties as a saved set or sub-set of message properties, said saved set or sub-set of message properties having an associated choice probability for at least one of the choice elements; and update the choice probability associated with the saved set or sub-set of message properties based on the determined choice element.

### BRIEF DESCRIPTION OF THE DRAWINGS

Embodiments of the present invention will now be described, by way of example only, with reference to the following drawings in which:

FIG. 1 is a deployment diagram of a system in accordance with aspects of the invention;

FIG. 2 is a component diagram of a choice model trainer in accordance with aspects of the invention;

FIG. 3 is a flow diagram of a process in accordance with aspects of the invention; and

FIGS. 4A, 4B, 4C and 4D are example messages and choice models in accordance with aspects of the invention.

### DETAILED DESCRIPTION

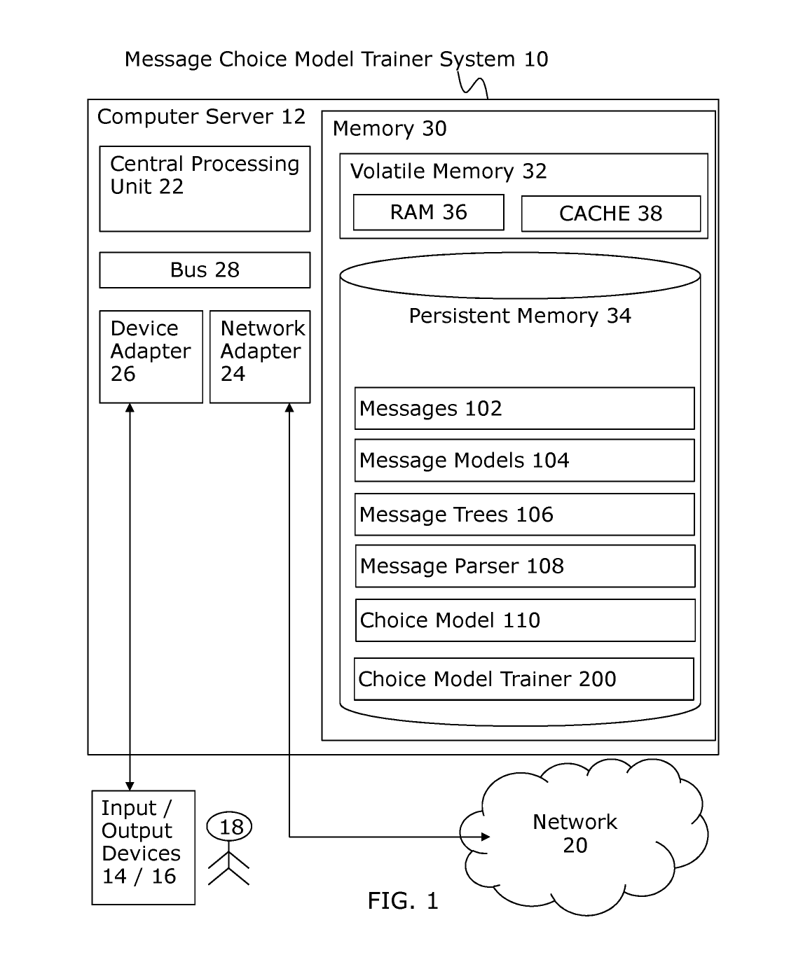

Referring to FIG. 1, the deployment of an embodiment of message choice model trainer system 10 is described. Message choice model trainer system 10 is operational with numerous other general purpose or special purpose computing system environments or configurations. Examples of computing processing systems, environments, and/or configurations that may be suitable for use with message choice model trainer system 10 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed computing environments that include any of the above systems or devices. A distributed computer environment includes a cloud computing environment for example where a computer processing system is a third party service performed by one or more of a plurality computer processing systems. A distributed computer environment also includes an Internet of things computing environment, for example, where computer processing systems are distributed as a network of objects that can interact with a computing service.

Message choice model trainer system 10 may be described in the general context of computer system executable instructions, such as program modules, being executed by a computer processor. Generally, program modules may include: routines; programs; objects; components; logic; and data structures that perform particular tasks or implement particular abstract data types. Message choice model trainer system 10 may be embodied in distributed cloud computing environments where tasks are performed by remote processing devices that are linked through a communications network. In a distributed cloud computing environment, program modules may be located in both local and remote computer system storage media including memory storage devices.

In embodiments, the message choice model trainer system 10 comprises: general purpose computer server 12 and one or more input devices 14 and output devices 16 directly attached to the computer server 12. Computer server 12 may be connected to a network 20. Message choice model trainer system 10 may communicate with a user 18 using input devices 14 and output devices 16. Input devices 14 may include one or more of: a keyboard; a scanner; and a mouse, trackball or another pointing device. Output devices 16 may include one or more of a display or a printer. Message choice model trainer system 10 communicates with network devices (not shown) over network 20. Network 20 can be a local area network (LAN), a wide area network (WAN), or the Internet.

Computer server 12 comprises: central processing unit (CPU) 22; network adapter 24; device adapter 26; bus 28 and memory 30.

CPU 22 loads machine instructions from memory 30 and performs machine operations in response to the instructions. Such machine operations may include: incrementing or decrementing a value in a register; transferring a value from memory 30 to a register or vice versa; branching to a different location in memory if a condition is true or false (also known as a conditional branch instruction); and adding or subtracting the values in two different registers and loading the result in another register. A typical CPU can perform many different machine operations. A set of machine instructions is called a machine code program; the machine instructions are written in a machine code language which is referred to as a low level language. A computer program written in a high level language is compiled to a machine code program before it can be run. Alternatively, a machine code program such as a virtual machine or an interpreter can interpret a high level language in terms of machine operations.

Network adapter 24 is connected to bus 28 and network 20 for enabling communication between the computer server 12 and network devices.

Device adapter 26 is connected to bus 28 and input devices 14 and output devices 16 for enabling communication between computer server 12 and input devices 14 and output devices 16.

Bus 28 couples the main system components together including memory 30 to CPU 22. Bus 28 represents one or more of any of several types of bus structures, including a memory bus or memory controller, a peripheral bus, an accelerated graphics port, and a processor or local bus using any of a variety of bus architectures.

Memory 30 includes computer system readable media in the form of volatile memory 32 and non-volatile or persistent memory 34. Examples of volatile memory 32 are random access memory (RAM) 36 and cache memory 38. Examples of persistent memory 34 are read only memory (ROM) and erasable programmable read only memory (EPROM). Generally volatile memory is used because it is faster and generally non-volatile memory is used because it will hold the data for longer. Message choice model trainer system 10 may further include other removable and/or non-removable, volatile and/or non-volatile computer system storage media. By way of example only, persistent memory 34 can be provided for reading from and writing to a non-removable, non-volatile magnetic media (not shown and typically a magnetic hard disk or solid-state drive). Although not shown, further storage media may be provided including: an external port for removable, non-volatile solid-state memory; and an optical disk drive for reading from or writing to a removable, non-volatile optical disk such as a compact disk (CD), digital video disk (DVD) or Blu-ray. In such instances, each can be connected to bus 28 by one or more data media interfaces. As will be further depicted and described below, memory 30 may include at least one program product having a set (for example, at least one) of program modules that are configured to carry out the functions of embodiments of the invention.

The set of program modules configured to carry out the functions of the preferred embodiment comprises: messages 102; message models 104; message trees 106; message parser 108; choice model 110 and choice model trainer 200. In one embodiment, ROM in the memory 30 stores the program modules that enables the computer server 12 to function as a special purpose computer specific to the program modules. Further program modules that support the preferred embodiment but are not shown include firmware, boot strap program, operating system, and support applications. Each of the operating system; support applications; other program modules; and program data; or some combination thereof; may include an implementation of a networking environment.

Messages 102 arrive at the message parsing system from other computer systems in the network and are stored in persistent memory 34.

Message models 104 comprise one or more models for defining how a message can be broken down into message elements.

Message trees 106 comprise one or more message trees. Each message tree comprises structured message elements parsed from a message to a message model.

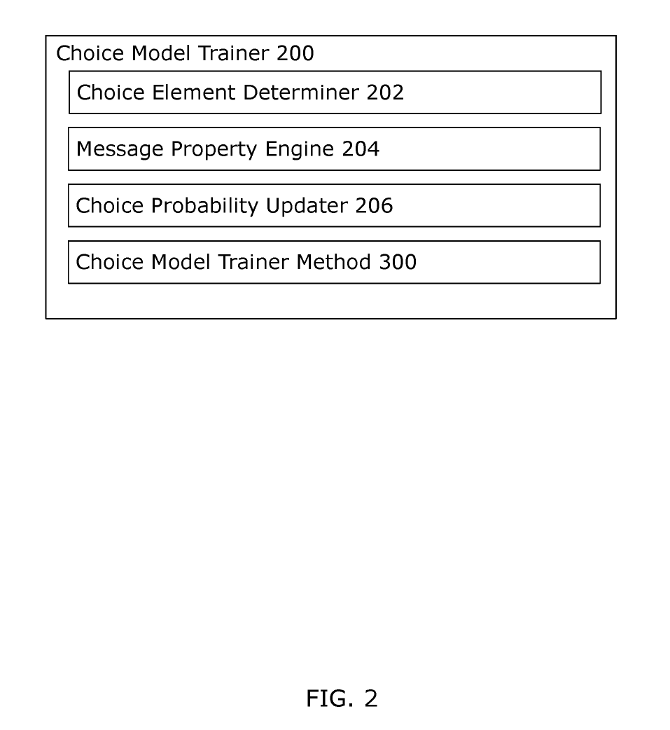

Message parser 108 is adapted for breaking down a message into message elements for a message tree according to a message model. Choice model trainer 200 is for optimizing the process of message parser 108 and is described in more detail with respect to FIG. 2 below.

Choice model 110 is adapted for storing choice options and choice option selections during message training whereby such choice options and selections are used to determine a highest probability choice option during an optimized parse.

Message choice model trainer system 10 communicates with at least one network 20 (such as a local area network (LAN), a general wide area network (WAN), and/or a public network like the Internet) via network adapter 24. Network adapter 24 communicates with the other components of computer server 12 via bus 28. It should be understood that although not shown, other hardware and/or software components could be used in conjunction with message choice model trainer system 10. Examples include, but are not limited to: microcode, device drivers, redundant processing units, external disk drive arrays, redundant array of independent disks (RAID), tape drives, and data archival storage systems.

Referring to FIG. 2, choice model trainer 200 is adapted for training a choice model for parsing message model choices. Choice model trainer 200 comprises the following components: choice element determiner 202; message property engine 204; choice probability updater 206; and choice model trainer method 300.

Choice element determiner 202 is configured for determining a choice element for a message during parsing. The determination of a selected choice element for a choice block in a message is performed before the message is fully parsed. Message property engine 204 is configured for determining that a message has the same set of message properties as a saved set of message properties, said saved set of message properties having an associated choice probability for at least one of the choice elements. Message property engine 204 is also for determining that the message properties are different from any saved message properties. Message property engine 204 is also configured for determining that a message has a sub-set of properties that are the same as a sub-set of saved properties. Each message field prior to a choice block is a potential message property. Message property engine 204 is also configured for identifying a reference set of message properties from all the save message properties to give an indication of the most probable element option in the choice block. Identifying a reference set of message properties comprises reducing all the message properties to a common set of message properties or a single common message property.

Choice probability updater 206 is configured for updating the choice probability associated with the saved set of message properties based on the determined choice element. Choice probability updater 206 is also configured for saving the message properties associated with a starting choice probability based on the determined choice element. Choice probability updater 206 is also configured for saving the determined sub-set of message properties associated with an adapted choice probability. Choice probability is a count representing the relative frequency that the choice element has been selected and updating the choice probability associated with the saved set of message properties based on the determined choice element comprising incrementing the count.

Choice model trainer method 300 is configured for controlling the components of choice model trainer 200.

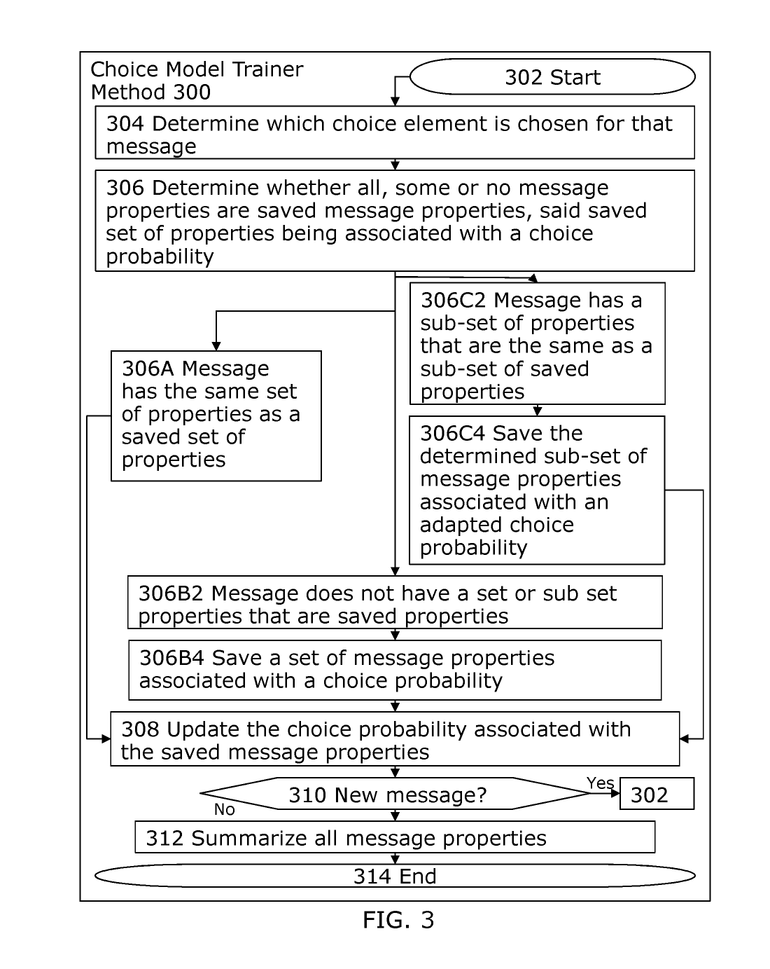

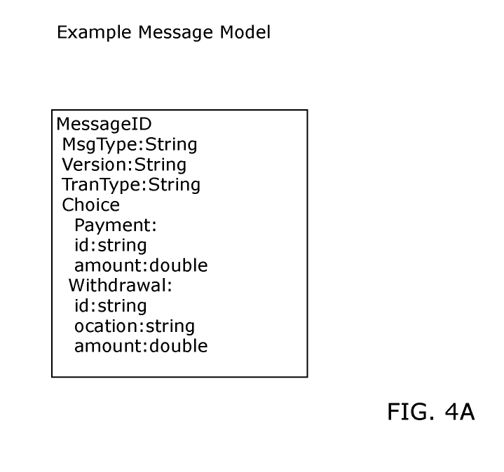

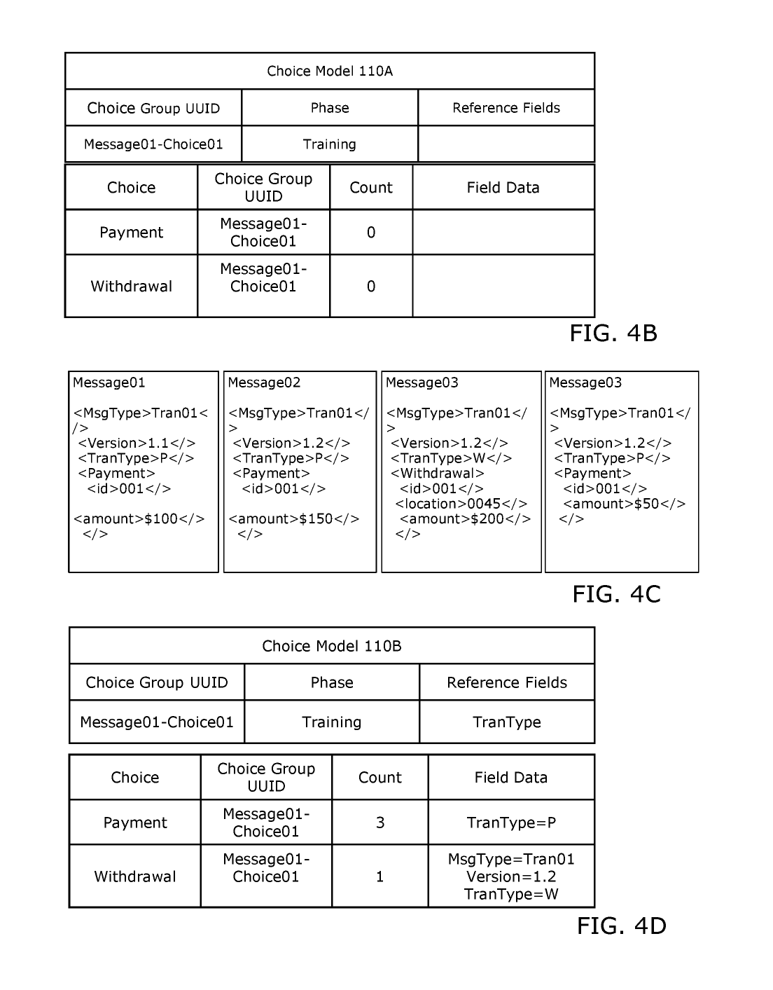

Referring to FIG. 3, an exemplary choice model trainer method 300 comprises logical process steps 302 to 314 for updating and creating a choice model 110 for use by a message parser in selecting message model choice options. In embodiments, and as described with respect to FIGS. 4A-D, the steps of the method are performed by one or more of the modules described with respect to FIGS. 1 and 2.

Step 302 is the start of the training method initiated during a parsing of a message model when an element choice is made from a choice block in a message model for a particular message.

Step 304 includes determining which choice element from two or more choice elements in a message model during parsing of a message. In one embodiment the parse trainer method is called after a choice element determination with the details of the choice element determination. Alternatively, a choice element determination is listened for and then details are fetched on occurrence of event.

Step 306 includes determining whether: A) all; B) some; or C) no message properties are saved message properties, said saved set of properties being associated with a choice probability. The method proceeds from respective steps: 306A; 30662; and 306C2 depending on whether all, some or no message properties are saved properties.

Step 306A includes determining when the message has the same set of properties as a saved set of properties. The next step is 308.

Step 306B2 includes determining when the message does not have a set or sub-set of properties that are saved properties

Step 306B4 includes saving the identifying set of message properties associated with a default choice probability. In the preferred embodiment the default is one. The next step is 308.

Step 306C2 includes determining when the message has a sub-set of properties that are the same as a sub-set of saved properties.

Step 306C4 includes saving the determined sub-set of message properties associated with an adapted choice probability by modifying field data in the choice model or creating a new choice probability with the sub-set of message properties. The next step is 308.

Step 308 includes updating the choice probability associated with the saved message properties.

Step 310 includes continuing training and starting again at step 302 with a new message if there is one. Step 312 includes identifying a reference set of message properties from all the saved message properties to give an indication of the most probable element option in the choice block. This comprises reducing all the message properties to a common set of message properties and/or to a single common message property. The preferred embodiment attempts to reduce the number of data fields that are needed so that a parser can guess a likely choice element to try first with as little work as possible. In one example, a trained choice model has a selection of message properties then a single common message property can be identified and saved in the reference field of the example choice model. In another example, more than one guide field is identified such as for different types of insurance policy depending on make and/or model of a car. In another example, no guide field can be determined or rationalized.

Step 314 is the end of choice model trainer method 300.

Referring to FIGS. 4A, 4B, 4C, and 4D, example messages and choice models usable in the method of FIG. 3 are described.

Referring to FIG. 4A, there is shown an example message model comprising: message type data field; a version data field; a transaction type; and a choice block data field. Message type data field is for a string value called MsgType. Version data field is for a string value called Version. Transaction data type is a string value called TranType and this is then followed by either a payment or a withdrawal data field. Choice block data field is a complex data field that comprises either a payment data field or a withdrawal data field. Payment data field comprises an id string field and an amount numerical field. Withdrawal data field comprises an id string field; a location string field and an amount numerical field.

Referring to FIG. 4B, there is shown an example choice model 110A including group data and a choice records data. The example choice group data model comprises: a choice group unique identifier (UUID) data field; a phase data field; and a reference data field. The choice group unique identifier (UUID) data field stores a unique reference for a particular choice group. The phase data field stores the phase status, for example “training” when training and “trained” when training is completed. The reference data field stores identifiers for data fields that are used to determine message properties. The example choice records data model comprises: a choice field; a choice group UUID; a count; and a properties data field. The choice field is for identifying a choice; for example, payment or withdrawal. The choice group UUID identifies what choice group the choice belongs to. The count field is a simple number to show relative levels of probability; in the preferred embodiment a simple count is used but in other embodiments a percentage value can be used. The data field holds the message properties that can help determine the most likely choice.

Referring to FIG. 4C, four example messages are considered: message01; message02; message03 and message04.

Message01 comprises: MsgType “Trans01”; Version 1.1; TranType “P” and a payment complex element. The “TranType” field is a separate field/element from the “Payment” or “Withdrawal” element, the example shows how the value in the “TranType” field can be used to determine whether the element that follows is either a “Payment” or a “Withdrawal” element. After a parse of the choice of message01 it is determined that the only message choice is a payment tag and therefore that the message choice is a payment and not a withdrawal (step 304). The embodiment determines that the properties for a payment comprises all the top level data fields and values and that no properties are already saved (step 306B2). MsgTyp=Tran01; Version=1.1 and TranType=P form the initial properties of a payment choice of the message model. The properties are saved (step 306B4) with payment message choice. The choice probabilities are updated (308) and the method repeats with a new message (step 302).

A whole message does not have to be parsed in the general case, just the correct choice. Implementations of the invention thus provide improvements to the function of the computer system performing the parsing by reducing the amount of the message that is parsed. In this example once the choice is parsed so is the message, but in other examples there may be sequential (non-choice) fields following the choice that will not need to have been parsed to update the reference data tables.

After a first parse of the whole message of message02 it is also determined that the only message choice is a payment and therefore that the message choice is a payment and not a withdrawal (step 304). The embodiment determines (step 306) that the properties for this payment comprise all the top level data fields and values, so that MsgTyp=Tran01; Version=1.2 and TranType=P form the characteristic properties of this message model.

However, it is also determined that some of these message properties (MsgTyp=Tran01 and TranType=P) are a sub-set of saved properties (MsgTyp=Tran01; Version=1.1 and TranType=P) so that they are already associated with a payment choice (step 306C2). Therefore, the determined sub-set of message properties (MsgTyp=Tran01 and TranType=P) are associated with an adapted choice probability. The properties are saved (step 306C4) with payment message choice. The choice probabilities are updated (step 308) and the method repeats with a new message (step 302).

After a first parse of the whole message of message03 it is determined that the only message choice is a withdrawal and therefore that the message choice is a withdrawal and not a payment (step 306B2). The properties are saved (step 306B4) with payment message choice. The embodiment determines that the properties for a withdrawal comprise all the top level data fields and values, so that MsgTyp=Tran01; Version=1.2 and TranType=W form the initial properties of a withdrawal choice of the message model. The properties are saved (step 306B4) with payment message choice. The choice probabilities are updated (308) and the method repeats with a new message at step 302.

After a first parse of the whole message of message04 it is determined that the only message choice is also payment tag and therefore that the message choice is a payment and not a withdrawal (step 304). The embodiment determines that the properties for this payment comprise all the top level data fields and values, so that MsgTyp=Tran04; Version=1.2 and TranType=P form the characteristic properties of this message model.

However, it is also determined that only one part of the message properties (TranType=P) is a sub-set of saved properties (MsgTyp=Tran01; Version=1.1 and TranType=P) and (MsgTyp=Tran01 and TranType=P) so that they are already associated with a payment choice (step 306B2). Therefore, the determined sub-set of message properties (TranType=P) is associated with an adapted choice probability and save with an incremented count of 3 (step 308). In this example there are no more messages.

Referring to FIG. 4D, there is shown an example choice model 110B updated from choice model 110A including group data and a choice records data. The reference data field has been updated (step 312) to a common data field for the choice block and in this case “TranType” is the common data field. The count field of the payment choice has been updated to a value of 3. The count field of the withdrawal record has been updated to a value of 1. The properties data field of the payment choice has been updated with “TranType=P”. The properties data field of the withdrawal record has been updated with “MsgType=Tran01”; “Version=1.2”; “TranType=W”.

The above embodiment is described with extendable mark-up language (XML) data but other non-XML binary format messages are envisaged where there are no “tags” and a parser looks for delimiters between fields and details about the field lengths and contents. The example in non-XML would be:

Message01: Tran01,1.1,P,001:$100

Message02: Tran01,1.2,P,001:$150

Message03: Tran01,1.2,W,001:0045:$200

Message04: Tran01,1.2,P,001:$50

In this non-XML example, the sequential data is separated by a comma and that in the choice element is separate by a colon. A parser parses Message01 until the first comma is located and preceding data is the “MsgType” (Tran01), the parser continues until the next comma (Version is then set to 1.1), and further continues until the next comma and TranType is set to P. In the choice the delimiter is set to a colon, so the parser now attempts to parse as a “Payment” as this is first in the message model order, the parser continues until the next colon and sets id to 001, and further continues to the end of file (no more colons) and so sets amount to $100.

If the parser attempts to parse Message03 in the same way then it parses until the first comma is located and the preceding data is the “MsgType” (Tran01), the parser further parses until the next comma (Version is then set to 1.1), and further parses until the next comma and TranType is set to W. The parse would attempt to parse as a Payment element so look for the next colon and sets id to 001, it continues to parse forward and to locate another colon instead of the end of the file, so there is an error and it is not a “Payment” element, so the parser rewinds back and attempts to parse as a “Withdrawal” element. The parser looks for the colon and sets id to 001, then looks for the next colon and sets location to 0045, then finds the end of file and sets amount to $200 and successfully parses the choice and message.

Further embodiments of the invention are now described. It will be clear to one of ordinary skill in the art that all or part of the logical process steps of the preferred embodiment may be alternatively embodied in a logic apparatus, or a plurality of logic apparatus, comprising logic elements arranged to perform the logical process steps of the method and that such logic elements may comprise hardware components, firmware components or a combination thereof.

It will be equally clear to one of skill in the art that all or part of the logic components of the preferred embodiment may be alternatively embodied in logic apparatus comprising logic elements to perform the steps of the method, and that such logic elements may comprise components such as logic gates in, for example, a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, the present invention may be realized in the form of a computer implemented method of deploying a service comprising steps of deploying computer program code operable to, when deployed into a computer infrastructure and executed thereon, cause the computer system to perform all the steps of the method.

It will be appreciated that the method and components of the preferred embodiment may alternatively be embodied fully or partially in a parallel computing system comprising two or more processors for executing parallel software.

A further embodiment of the invention is a computer program product defined in terms of a system and method. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be clear to one skilled in the art that many improvements and modifications can be made to the foregoing exemplary embodiment without departing from the scope of the present invention.

What is claimed is:

1. A message choice model trainer system for training a choice model for use by a parser when parsing message model choices, said message choice model trainer system comprising:
a processor, a computer readable memory, and a computer readable storage medium associated with a computer device;
program instructions of a choice element determiner configured to determine a choice element for a message model and message during parsing;
program instructions of a message property engine configured to determine that the message has the same set of message properties as a saved set of message properties, said saved set of message properties having an associated choice probability for at least one of the choice elements; and
program instructions of a choice probability updater configured to update the choice probability associated with the saved set of message properties based on the determined choice element,
wherein the program instructions are stored on the computer readable storage medium for execution by the processor via the computer readable memory.

2. The message choice model trainer system according to claim 1 wherein:
the message property engine is further configured to determine that the message properties are different from any saved message properties; and
the choice probability updater is further configured to save the message properties associated with a starting choice probability based on the determined choice element.

3. The message choice model trainer system according to claim 1 wherein:
the message property engine is further configured to determine that a message has a sub-set of properties that are the same as a sub-set of saved properties; and
the choice probability updater is further configured to save the determined sub-set of message properties associated with an adapted choice probability.

4. The message choice model trainer system according to claim 1 wherein:
the choice probability is a count representing the relative frequency that the choice element has been selected; and
the updating the choice probability associated with the saved set of message properties based on the determined choice element comprises incrementing the count.

5. The message choice model trainer system according to claim 1 wherein the determination of a determined choice element for a choice block in a message is performed before the message is fully parsed.

6. The message choice model trainer system according to claim 1 wherein all fields prior to a choice block are message properties.

7. The message choice model trainer system according to claim 1 wherein the system is configured to identify a reference set of message properties from all the saved message properties to give an indication of the most probable element option in the choice block.

8. The message choice model trainer system according to claim 7 wherein the identifying a reference set of message properties comprises reducing all the message properties to a common set of message properties.

9. The message choice model trainer system according to claim 7 wherein the identifying a reference set of message properties comprises reducing all the message properties to a single common message property.

10. The message choice model trainer system according to claim 1 wherein the determination of a determined choice element for a choice block in a message is performed after the message is fully parsed.

11. A computer implemented method for training a choice model for parsing message model choices, said method comprising:
determining, by a computer device, a choice element for a message model and a message during parsing;
determining, by the computer device, that the message has the same set of message properties as a saved set of message properties, said saved set of message properties having an associated choice probability for at least one of the choice elements; and
updating, by the computer device, the choice probability associated with the saved set of message properties based on the determined choice element.

12. The method according to claim 11 further comprising:
determining that the message properties are different from any saved message properties; and
saving the message properties associated with a starting choice probability based on the determined choice element.

13. The method according to claim 11 further comprising:
determining that a message has a sub-set of properties that are the same as a sub-set of saved properties; and
saving the determined sub-set of message properties associated with an adapted choice probability.

14. The method according claim 11 wherein:
the choice probability is a count representing the relative frequency that the choice element has been selected; and
the updating the choice probability associated with the saved set of message properties based on the determined choice element comprises incrementing the count.

15. The method according to claim 11 wherein the determination of a choice element for a choice block in a message is performed before the message is fully parsed.

16. The method according to claim 11 wherein all fields prior to a choice block are message properties.

17. The method according to claim 11 further comprising identifying a reference set of message properties from all the saved message properties to give an indication of the most probable element option in the choice block.

18. The method according to claim 17 wherein the identifying a reference set of message properties comprises reducing all the message properties to a common set of message properties.

19. The method according to claim 17 wherein the identifying a reference set of message properties comprises reducing all the message properties to a single common message property.

20. A computer program product for training a choice model for use by a parser when parsing message model choices, the computer program product comprising a computer readable storage medium having program instructions embodied therewith, the program instructions executable by a processor to cause the processor to:
determine a choice element for a message model and message during parsing;
determine that a message has the same set or sub-set of message properties as a saved set or sub-set of message properties, said saved set or sub-set of message properties having an associated choice probability for at least one of the choice elements; and
update the choice probability associated with the saved set or sub-set of message properties based on the determined choice element.
